(19) United States
(12) Patent Application Publication
(10) Pub. No.: US 2002/0143764 A1
(43) Pub. Date: Oct. 3, 2002

(54) Data management system and method for intercepting and changing database instructions between a database back end and an application front end

(76) Inventors: Andrew R. Martin, Austin, TX (US); Jeffrey J. Goke, Austin, TX (US)

Correspondence Address: WILSON SONSINI GOODRICH & ROSATI, 650 PAGE MILL ROAD, PALO ALTO, CA, 943041050

(21) Appl. No.: 09/825,236

(22) Filed: Apr. 3, 2001

(51) Int. Cl. G06F 7/00

(52) U.S. Cl. 707/8

(57) ABSTRACT

A database method and system use one or more virtual driver interceptors (106) to intercept information and/or queries provided between a database backend system (112) and an end user front end system (102). The interceptors (106) can dynamically alter information or queries that are intercepted in transit between the backend (106) and the applications (102). The effect of altering this information dynamically between the back end and front end is that the system (100) has more functionality, greater flexibility, and/or enhanced performance without the need the change, at great expense and cost, all of the software and/or hardware within the backend (112), standard drivers (110), APIs (104), and applications (102). For example, the changing of instructions via the virtual driver (106) allows for dynamic data versioning, caching, fault tolerance, data backup, statistical data monitoring, load balancing, space planning, data conversion, enhanced security, and/or the like without the need to significantly change the system

### FIELD OF THE INVENTION

The present invention relates to an apparatus and method for intercepting and changing database information flowing between a back end system and a front end system and more particularly to, dynamically changing information and instructions in driver software to enable additional database functionality without need to alter the complex, expensive, and already-deployed front end applications, application programmer interfaces (APIs), the back end standard drivers, and the database back end constructs.

### BACKGROUND OF THE INVENTION

Only in the past few decades has the electronic exchange of information become a multi-billion dollar industry. In its simplest form, electronic or digital information communication involves at least two parties as does any communication. There is a first party that creates the information and a second party that is to receive the information. In today's information age, the cost, time, and complexity of creating information, requesting information, and delivering information to other parties is becoming ver high. Therefore, the ability of a company to rapidly create, change, and deploy data to the marketplace in a user friendly manner is critical to that businesses success. Furthermore, end users and customers continue to demand, fast, changing, continually updated, and massive access to information, and successful businesses must meet these demands or lose market share to competitors that do improve their data creation and delivery systems.

Electronic or digital information can be categorized broadly into two different types. A first type is static information. Static information is information that is not hierarchical or relationship interwoven. Static information is not data tagged with field identifiers for easy access, manipulation, and searching. Static content includes such material as text documents, GIF or JPEG pictures, MP3 files, HTML, most software, and other types of information. On the other hand, database information, a second type of information, is dynamic. The information contained within a database is indexed by data fields, is often hierarchically arranged, and often embodies interrelationships between the data present within the database. Therefore, dynamic data, which much more complex that static data, offers constructs that are much more powerful and useful than static data in many applications. In order for a company to succeed in a marketplace, both static and dynamic information must be created and presented to an end user in a fast, cost-effective, and efficient manner.

FIG. 1 illustrates a prior art method by which static content may be created and provided to end users. FIG. 1 illustrates a construct of static files 10. The static files 12-16 may be text documents or word processing documents, pictures, software, or other static data types. Specifically in FIG. 1, text documents (e.g., Word 97 documents) are illustrated. In FIG. 1, a first user, Jill, may gain access to a static data file repository via an application and create a text letter illustrated as letter 12 in FIG. 1. The owner of this letter, Jill, can make modifications and changes to the letter and provide the static letter content out to end users in an effective manner. In addition, other users that have access to the static data repository 10 may copy Jill's letter 12 into a new letter 14 as was done by a user named Pete in FIG. 1. A new owner, Pete, can then change the static content of the Jill's letter 12 to result in a new letter 14 without affecting Jill's original letter 12. In essence, a second version of the letter 14 is created from the first version of the letter 12 allowing both Jill and Pete to work on different versions of the letter in parallel to each other without affecting each other's content.

In addition, an added benefit is that Pete was able to capitalize on previous work from Jill whereby Pete can provide his letter to his end user much faster than if Jill's version 12 had not been available. In addition, Jill's version 12 is still present in its original state whereby Jill, after creation of letter 14, can create a third version 16. This version 16 allows Jill to create yet another letter, capitalizing on her previous work, while not destroying her previous version 12 and while leaving the letter 14 unchanged. In essence, all word processors, and static document handling systems allow for such versioning where static content created by one user may be versioned and copied to many other instantiations whereby many different users can be simultaneously processing multiple versions and capitalizing on previous versions' content without destruction of the previous content.

However, in FIG. 1, since the information stored within the versions 12, 14, and 16 is static information, some flexibility of content exchange between the versions 12, 14, and 16 is lost or at least very difficult. For example, since the static information of FIG. 1 is not indexed based on data fields or other database constructs, non hierarchical, etc., a portion of Pete's letter 14 cannot be rolled back and forward between Jill's letter 12 and relationships between Pete's letter and Jill's letter cannot be processed. In addition, a hybrid combination of the letters 12 and 14 cannot be used to create a later version such as letter version 16. This is due to the fact that the information in FIG. 1 is static, and a user does not have any field information, relationship information, hierarchy, or identifier information with static content through which greater efficiency and faster creation of information can be obtained. This one drawback of static content.

FIG. 2 illustrates a known database system that assists somewhat in quick dynamic data generation and its static delivery to end users. In essence, the system 20 of FIG. 1 is used to perform versioning in a manner similar to the static content illustrated in FIG. 1. The system 20 of FIG. 2 contains a database working file 22. The file 22 contains dynamic content and that dynamic content can be manipulated by data creation personnel. The database working file 22 is connected to a backup data storage bank 24. Since the working file 22 can only manipulate one set of data at a time, the storage 24 is needed to store all versions of the data, that are not currently being processed by the working file 22, in a static form.

For many applications, dynamic database constructs, as in FIG. 2, are more powerful than the static constructs illustrated in FIG. 1 since the information within the database working file 22 is hierarchically organized, identified by fields, and may contain relational information between data fields. Specifically, the database working file 22 contains multiple data tables or constructs. Specifically, two data tables 42 and 44 are illustrated in FIG. 2. The data table 42 is a data table containing information related to women's swimsuits. And, by way of another example, the table 44 contains information related to toys. Each dynamic data table contains columns which identify characteristics of the various items contained within the particular table. For example, table 42 has at least five columns wherein each column contains different information related to swimsuits, such as name of the swimsuit, type of the swimsuit, the color of the swimsuits, a size of the swimsuit, and a price for the swimsuit. In table 44, the columns contain name information, product number information, the appropriate age for the toy, a manufacturer of the toy, and a price for the toy.

Within each of the tables 42 and 44 are individual records that are organized as rows within the table. For example, the women's swimsuit table 42 is illustrated as having at least two records 42a. The top record 42a is shown as having at least five data fields or data entries 42b. For example, for the top record 42a in table 42, the name of the swimsuit is identified as XC724, the type is identified as a bikini, the color is identified as blue, the size is identified as small, medium or large, and the price is identified as $59.99. All records 42a within the table 42 will contain such information. Likewise, the table 44 contains records 44a which contain data entries or data fields 44b corresponding to the information attributed to each column.

FIG. 2 illustrates one method for attempting to combine static versions of dynamic data in the hopes of rendering a database application more flexible. Assume for the purposes of FIG. 2 that the user of the database is a commercial retailer and desires each year to process a winter catalog, a spring catalog, a summer catalog, and a fall catalog for its consumers. When using database constructs to create these catalogs, a first set of static archival catalog information must be loaded into the database working file 22. Such an operation generally takes significant IT hours and support and is not an easy or cost-effective operation to perform in many cases. Therefore, if a winter catalogue is desired, winter catalog information is either entered into the fields of the tables 42 and 44 or archival information from the storage 24 is loaded (wiping out the existing data in file 22) at great expense, lost time, etc.

Eventually, over time, all the data in the winter catalog is dynamically completed in file 22. However, since there is only one database working file that is surrounded by expensive and custom software necessary to access and change the database, only the winter catalog team may have access to the database working file 22 at this time. Therefore, the spring, summer, and fall catalog team does not have access to the database working file 22 and cannot engage in their work since the file 24 is backup and not active working file data. Once the winter catalog is believed to be complete, in order to move on to the spring catalog, the winter catalog must be dumped to static backup storage 24 and an end user, static-content version of the winter catalog must be created to a static file 26. Now users may access a winter catalog 26 from various applications or web-based systems while the winter data within the database working file 22 is destroyed with spring catalog data via a data move from the storage 24 to the file 22.

Should there be an error in the winter catalog data or should changes need to be made, the spring catalog data would need to be dumped to the database 24, destroyed in file 22, and backup information for the winter catalog would then be loaded from the database 24 back into the working file 22. This exchange would prevent and delay the spring team from working on their spring catalog and results in significant overhead, lost time and expense. Such a serial process of creating winter, spring, summer, and fall catalogs occurs year round with each group thrashing over access to the common database working file 22 as dynamic changes need to be made to their specific catalogs.

Therefore, FIG. 2 illustrates that database versioning in a dynamic database system is, with current technology, a very difficult application to create and operate. In addition, FIG. 2 illustrates the fact that expensive and custom software wrapped around a database significantly limits an end user's use of that system since versioning changes to new constructs, memory location, structures, etc., would require all these programs and resources to be changed or duplicated in a custom manner for each version, which, as stated before, is costly and time consuming. Any change to the database working file structure usually requires significant changes to the software where these significant changes to the software for any one catalog team could result in loss of data, loss of time to market or other problems with other catalog teams. Therefore, a need to efficiently and effectively version data or dynamically select processed data within a database working file without requiring the need, to at great expense and through great time, change all of the complicated software surrounding the database working file is needed by the electronic communications industry.

In essence, databases are generally more powerful for information processing than static content since information can be referenced in a hierarchical, relational, and field tagged manner. Databases have found their place in applications where significant amounts of data need to be processed and changed on a periodic basis and presented to end users or other businesses which require the information in order to conduct business or engage in a transaction. Such dynamic data processing is not generally possible in static content files, however, dynamic data processing has its price. As should be understood, since database content is far more complicated than static content, the backend database programs, drivers, application programmers interfaces (API's) and applications are usually custom-tailored to take advantage of the specific database structure, tables, records, fields, and interrelationships between the data present within a database working file 22 (see FIG. 3, which will be discussed in more detail later). Software that is written to access and change information within the database generally has to be fine-tuned and custom-modified to take into account the various field names, tag names, constructs, hierarchy, relationships, and data contained within a specific database working file 22.

Therefore, the software wrapping around a database working file 22 is generally custom-created, over long time periods, at great expense once the construct of a database working file is defined. Any changes to the database working file after that point in time will likely result in significant and expensive changes being required to the software that wraps around the database working file and allows access to the data and changes to be made to the data. Generally, most end users suffer these inconveniences and paid millions of dollars to retool API's, drivers, applications and backend systems as changes, and wait months or years to retool dynamic data systems as their data and databases evolve over time. Even then, some changes or desired dynamic features are just so expensive and complex that their creation, while very beneficial, is not pursued by a company. Therefore, due to the complexity of a database system, its upgrading, enhancements, and seamless integration with surrounding software, versioning, and other dynamic processing of data within a database very difficult if not impossible in most applications.

FIG. 3 illustrates a database system which may be used to implement the processing discussed with respect to FIG. 2. The database working file 22 and its contents can be stored on one or more database backends 58 illustrated in FIG. 3. In addition, the system 50 of FIG. 3 illustrates the software that wraps around the database working file, which was previously discussed with respect to FIG. 2. In FIG. 3, database drivers 56 are used to interface to the database backend 58. Application programmer interfaces (API's) 54 are used to communicate with the database drivers 56, and end users use interface to data through one or more application programs 52. The application programs 52 collect user input and user desires and communicate that information to the API's 54. The API's will communicate information to the drivers 56 requesting certain information from the database backends. The drivers then communicate with the backends 58, collect information from the database, and then provides the information back through the API's 54 to the applications 52. At this time, a user can see the data that he requested in a certain format.

It is important to note that in most cases, the applications 52, the API's 54, the drivers 56, and the software and construct located at the database backend 58 are integrally a part of each other. Changes to the database backend 58 to change the data environment, hierarchy, construct, tagging, locations, etc., or any other type of dynamic change of the system results in changes needing to be made within one or more of the applications 52, the API's 54, and the drivers 56. Given that there are hundreds of drivers available and deployed for databases and given that APIs, applications, and database systems contain large, expensive, and complicated pieces of software, the process of changing all these pieces of software and systems to accommodate new versions or dynamic change of data within the file 22 is generally a very onerous task that may occur over and over again as an industry matures and adds or subtracts to and from its data system.

Therefore, there is a need in the industry for a database system that allows for dynamic control, versioning, access changing, caching, dynamic interception, and like processing of dynamic content at the database backends 58 without requiring significant, time-consuming, and costly changes to the software portions contained within the objects 52, 54, 56, and 58.

### BRIEF DESCRIPTION OF THE DRAWINGS

FIG. 1 illustrates, in a block diagram, a prior art method for versioning static information within a static data system.

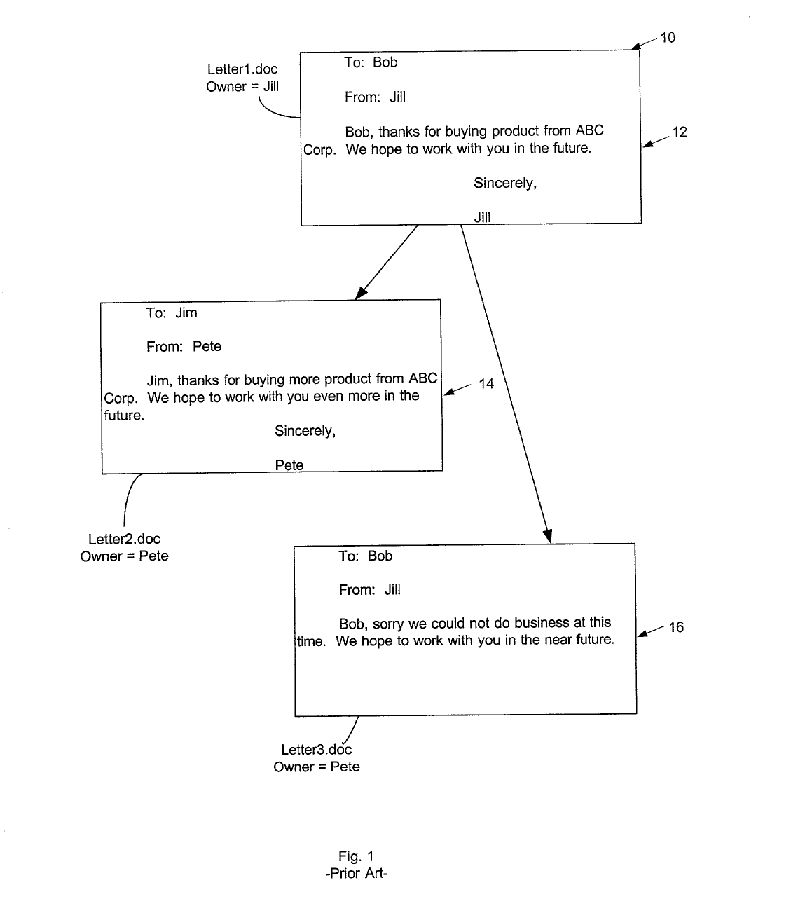

FIG. 2 illustrates, in a block diagram, a prior art method for time sharing dynamic content in order to generate different versions of static content from a dynamic database context.

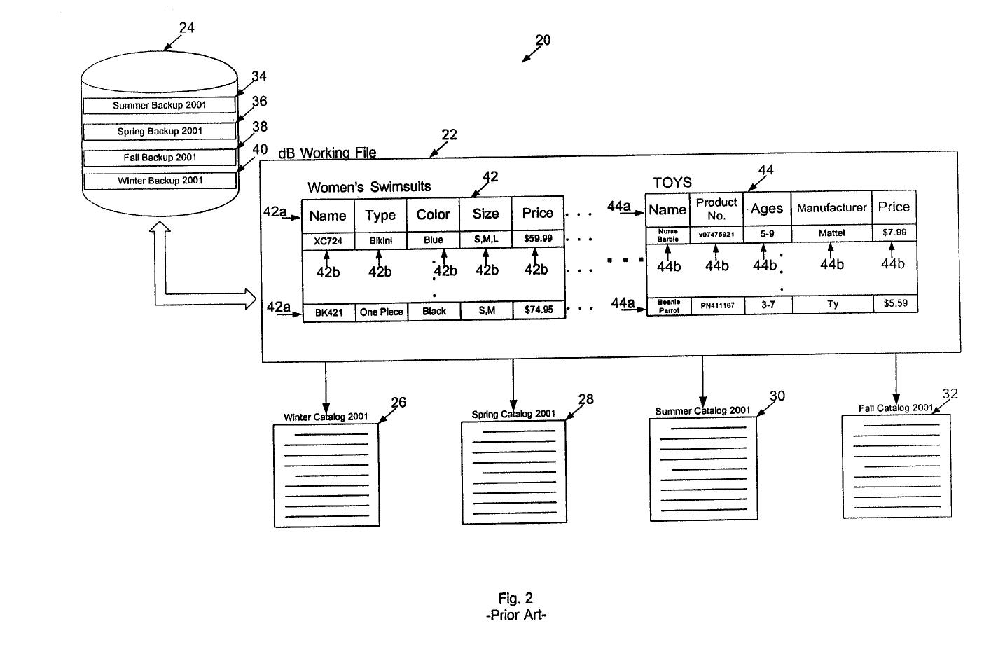

FIG. 3 illustrates, in a block diagram, a prior art system for communicating database backend information to and from end user application programs with complex, costly, and custom software modules.

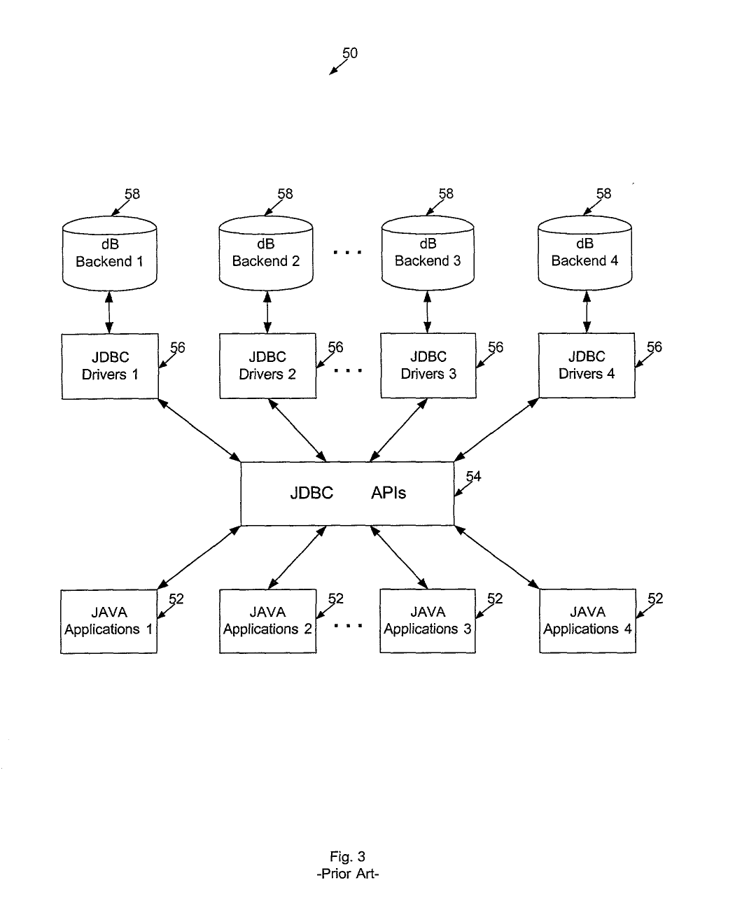

FIG. 4 illustrates, in a block diagram, virtual interceptor software used within a database system to allow data at the database to be changed (e.g. versioned) without the need for significant, time consuming, and expensive alteration in drivers, API's, applications, and/or the database backend.

FIG. 5 illustrates, in a block diagram, virtual interceptor software that is configured as wrapper software around only a subset of the objects or software routines within driver software portions of the system.

FIG. 6 illustrates, in a block diagram, virtual interceptor software that is layered across all objects or software routines within driver software portions of the system.

FIG. 7 illustrates, in a flow chart, the process by which the system of FIG. 4 is able to perform non-intrusive dynamic modification of data and constructs within a backend database.

FIG. 8 illustrates, in a block diagram, how the system of FIGS. 4 and 5 versions or dynamically alters the backend database to improve utilization of a database.

FIG. 9 illustrates, in a block diagram, one specific method which may be used to version information within the system of FIG. 4.

FIG. 10 illustrates, in a block diagram, yet another method which may be used to version dynamic data within a backend database as shown in FIG. 4.

FIG. 11 illustrates, in a block diagram, a two-tier versioning approach whereby the system of FIG. 4 may be programmed to version based on user input or content and further version within that version based upon time or another criterion.

### DETAILED DESCRIPTION

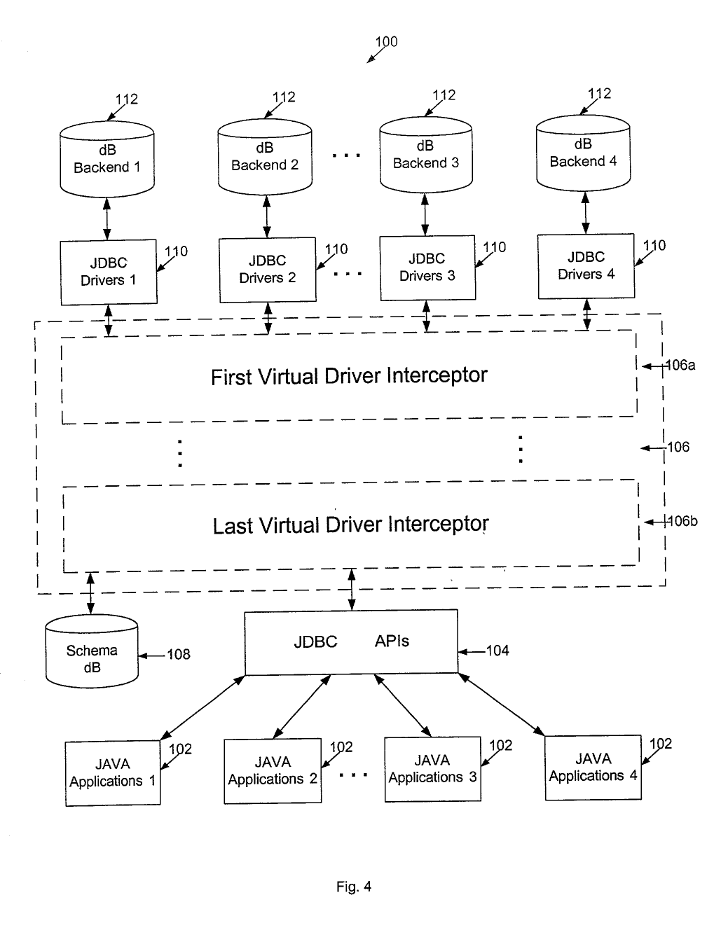

Generally, FIGS. 4 through 11 teach a system, software, and method in which a wrapper layer or a virtual driver interceptor is inserted between the backend and the front-end of a database system. The wrapper allows multiple versions of dynamic data and databases to be formed on the backends by end-users or by other application programs and/or allows for dynamic alteration of the database over time. A benefit is that this dynamic alteration to the system can be performed while allowing existing database drivers, API's, and existing applications to interface with all of these versions without need of change and without incurring great expense. The existing drivers, API's, and applications can be used in substantially their same form while the virtual driver adds dynamic flexibility to the system.

In essence, the applications and the API's interface to the drivers in the backend as though they were interfacing with a single known version of the data that appears as though it has not changed since it original inception. However, the virtual driver interceptor or wrapper code are being used to intercept instructions passing between the backend and the front-end and manipulating or changing the instructions based upon user data, system data, schema data, or version data so that the specific user or system that is accessing the database can obtain data from one of several data versions or dynamically changed data files seamlessly and independently of intervention by the end-user. By using the virtual driver interceptor or wrapper code taught herein, an end-user can save significant hours of IT support, save significant cost in changing or custom modifying drivers, APIs, database backend code, and application software, and save significant downtime and data manipulation time in backend database systems and at the same time obtain greater flexibility and improved functionality. In addition, the database information stored on the backend system can be versioned, shadow copied, dynamically altered, and/or manipulated in multiple instantiations whereby multiple versions of dynamic data can be processed in parallel to one another at any given time without users continually thrashing over limited dynamic database backend resources.

The database system and method taught herein can be further understood with specific reference to FIGS. 4 through 11.

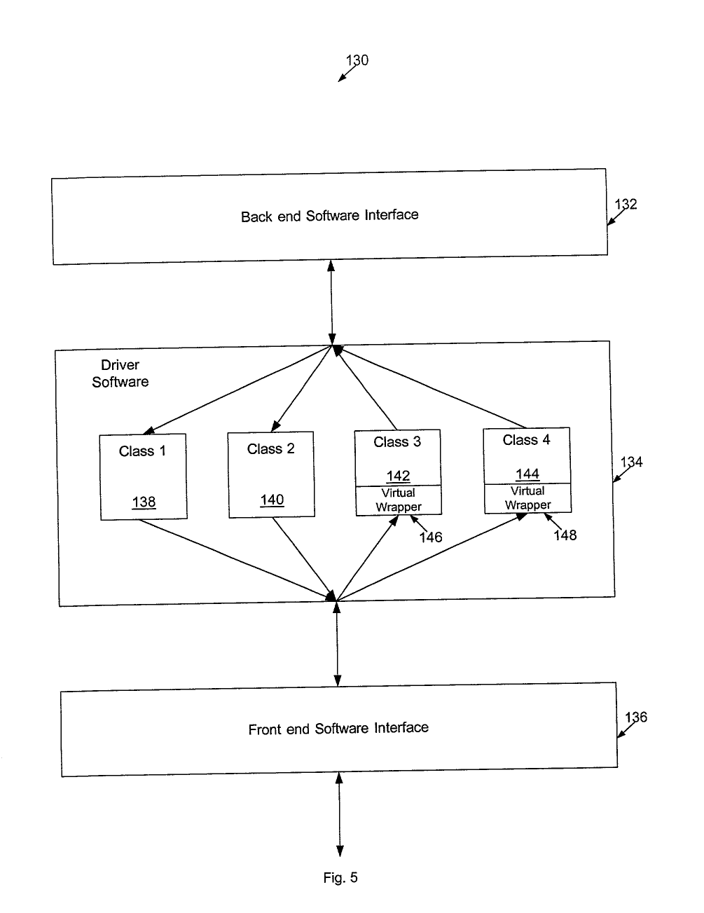

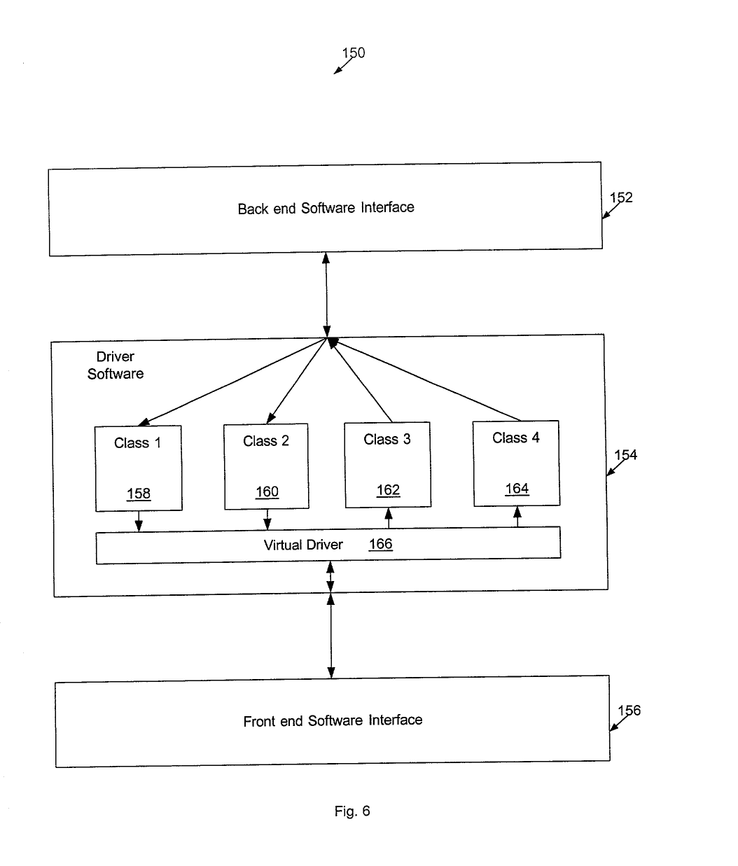

FIG. 4 illustrates a database and a data management system 100. In system 100, one or more application programs 102 may be used by end-users, customers, or database entry teams. Some application may be read/write utility applications for building, modifying, or copying data in the back end while other applications are for end users that desire to query, process, and view certain data in the back-end. While Java embodiments are illustrated in FIG. 4, it should be understood that other programming languages or systems (e.g., C++) may be implemented using the teachings of FIGS. 4-11. The application programs 102 communicate with the application programmer interfaces (APIs) 104. The API's communicate with a stack of one or more virtual driver interceptors 106, each configured in either a wrapper or virtual layer format (see FIGS. 5-6). The stack of one or more drivers 106 will contain one or more virtual driver interceptors. Specifically, at least two interceptors 106a and 106b are specifically illustrated in FIG. 4. The stack of virtual driver interceptors 106 interfaces with one or more standard backend drivers 110, and there are hundreds of existing standard drivers existing in the industry. The function of the virtual drivers 106 and how they obtain the added functionality and flexibility in the system 100 is discussed in detail below. The drivers 106 communicate with backend storage and server devices 112 to write and/or read information to or from backend databases.

The presence of virtual driver interceptor stack 106 provides various benefits to the system 100 over the prior art. In order to show the usefulness of the stack 106, several examples will now be discussed. First, assume that a database user has already paid significant amounts of money and invested significant time in deploying existing applications 102, APIs 104, drivers 110, and database backends 112. These systems may take months or years to build and will cost millions of dollars. In addition, assume that these systems have been used for a long period of time and have accumulated a large body of useful commercial data that is now difficult to copy as a whole or wholly augment. Nonetheless, at some point, the database user may wish to alter the data resident within the database backends 112, change the construct, structure, or organization of the data in the backend, version data in the backend so that multiple versions of different data can be resident in the backend at a same time, perform data caching, enhance security, perform fault tolerance backup and access, do database or access statistical analysis, do space or capacity planner, or otherwise change the configuration, functionality, or content of data or system in FIG. 4. In most cases, in prior art systems, such changes would result in programmers having to extensively modify and edit the drivers 110, the API's 104, the applications 102, and the backend 112 at great expense, significant development time, and the impact of possible downtime. In addition to the pain and cost of making such modifications, it would be just as difficult to go back in time to the previous configuration if the new configuration or new data was not working well for the database user. However, the presence of the virtual driver interceptor stack 106 makes such modifications to database backends much simpler, more flexibly, and more cost-effective.

For example, assume that the database backend 112 contains base data that is to be used to create a winter catalog. It is likely that before the winter catalog is released a spring catalog team would like to develop spring catalog data and be able to use the system 100 of FIG. 4. In this case, the spring catalog team may enter system 100 and select the tables, data, records or like constructs from the backends 112 that they wish to use and duplicate that data into a new version on one or more backends 112 (or a totally different set of backends added to the system 100 if such is preferred by the user). At this point in time, both a dynamic data winter catalog and a dynamic data spring catalog are resident on the backend systems in a fully functional database format. Using prior art systems of the past, this creation of an additional database file would result in the need to significantly change the drivers 110, API's 104, applications 102, and databases 112. With the virtual wrapper 106 in place, a single virtual driver interceptor 106a may be created and layered into the virtual driver software 106 to augment the drivers 110 to handle one or more new versions of data in a quick, non-intrusive, cost-effective, and simple manner.

In the case of versioning, which is our current example, the virtual driver interceptor 106a can be designed to intercept instructions coming from the applications 102 to the backends 112. Once these instructions are intercepted and recognized as accessing backend data, a schema database 108 or like version information can be accessed by the virtual driver interceptor 106a. Data on the schema database 108 will indicate whether or not this specific user or the system that is accessing the backend database is on the winter catalog team or the spring catalog team. Once this information from the database 108 or any other source is obtained by the virtual driver interceptor 106a, the incoming instruction from the application can be modified to form modified instruction, dynamically routed to different destinations, or otherwise processed dynamically so that the backend data that is accessed by this particular query will access the correct version for the specific system and/or user that is making the request/query. Therefore, existing applications, API's, drivers, and backends can be used as they always have to access multiple versions of different data stored in the backend storage 112 by virtue of instruction interception at the stack 106 coupled with user or system identification data stored within the schema database 108 or another source. In essence, the use of any virtual interceptor layer will allow new functionality to be present within the system 100 without requiring significant alteration or changing to the already expensive and time-consuming infrastructure set forth in FIG. 4. In other words, the expensive and complex databases, APIs, applications, and standard/existing drivers believe that they are communicating with each other as they always have while the virtual wrappers and/or drivers in the stack 106 “trick” the system into actually appearing and multiple systems or having additional functionality when it otherwise could not have that functionality or additions.

As another example, various applications 102 may be distributed to many different departments or divisions of a corporation or to many different customers. In certain circumstances, the owner of the data that is residing in the database 112 would like only certain individuals, certain customers, or certain systems to have access to certain data. For example, a human resources department may have different access to corporate data that is different than the access granted to the personnel in the advanced research product and development laboratory. An executive vice president in the company may have different access to information within the backend systems 112 that is restricted from access by a contract consultant resident in the same facility. Therefore, the use of the virtual interceptor 106 can provide different user access levels or security levels within the system 100 without requiring significant change to the backend 112, the drivers 110, the API's 104, and/or the applications 102. Security or different user access can be achieved by intercepting incoming queries at the virtual driver interceptor stage 106. Once intercepted, the query can be analyzed via control information present from the database 108 to indicate whether or not this specific user or computer system has proper authorization to access the data that has been requested by the query. If the data requested is proper for this particular user system, then the instruction may be passed on to the backend databases 112 for information access. However, if the database information in storage 108 indicates that this is not a proper query for this specific user, for the current conditions (i.e., time of day), or system, then the virtual driver interceptor 106 may transmit a null command to the backend or prevent that query from reaching the backend databases 112 at all. In another form, people with a certain level of security will get access to a certain version of data in the backend whereas other levels of security or user access will result in access to different versions of data in the backend. For example, human resources may get access to a version of data that has salary information wherein the general employee's database will be void of this information. This way, some databases at the backend may contain more sanitized or simplified pieces of information whereas more sensitive information in other versions are only enabled for access by a select few people in the corporation.

For large organizations, the database system 100 of FIG. 4 will eventually grow over time to become larger and larger. As this system expands, the complexity of this system also expands. In these cases, the wrapper 106 may be used to intercept instructions to data or databases that were not present in the original system and modify such instructions so that they are processed properly without the need to completely overhaul the rest of the pieces within system 100. In this manner, new tables, fields, constructions, or entries may be added without requiring a complete overhaul of the whole system 100 of FIG. 4.

Furthermore, data tracking and data time/date stamping has become important for most corporations. However, most corporations base data systems are years old and do not accommodate such functionality as first installed. In these cases, a wrapper 106 may be used to intercept instructions coming to and from the backend and the front-end applications and mark these queries and changes to the database with user information, system information, time stamps, date stamps, or like information. That information may be cached or may get written into one or more backend system tables as additional linked data to existing tables in the system. As stated previously, the virtual driver interceptor 106 can engaged in such functions without requiring significant change to the rest of the system 100. Therefore, without significant investment or lost time, the data now being retrieved and stored within the database can be tracked by user access, user change, time of access, and/or frequency of access.

In addition, one or more of the virtual driver interceptors 106 may be used to perform caching of information that has been received from the backend databases 112. Therefore, if an application 102 selects specific information from a database 112 over and over again or if common information is tagged by an information technology (IT) file as being commonly accessed, a virtual interceptor 106 can perform caching operations in an adjacent database similar to database 108. Once cached in fast disk array or memory, if this information is repeatedly requested by a user, it can be provided in a much faster and more efficient manner to the end-user without continually accessing the slower backend databases 112.

Furthermore, the system of FIG. 4 may contain virtual wrappers or layers 106 that perform many other functions. Some examples include the ability to dynamically shadow copy a database or make a functional dynamic backup copy that is accessed as though it were an original. This database backup may be kept current to the primary database file by a virtual driver intercepting write instructions and shadow writing a copy of the data into the backup over time. If the system detects that the primary database is down, not functioning properly, under maintenance, etc., then the system can automatically detect such problem or be IT set to access the backup copy of the database. The virtual driver may capture all changed to the database in a cached file so that once the original database comes back on line, the changes made to the backup while the primary was inoperable may be written back to the primary to maintain data coherency between the copies. The virtual wrapper or driver can be used to intercept instructions to perform statistical analysis or collect access/user information. The virtual wrapper or driver may be used to dynamically and intelligently perform space and capacity planning and analysis for an IT department. The new uses for a virtual wrapper or driver layer are vast.

In addition to its individual flexibility, it is important to note that all or some subset of all of these functional features (i.e., versioning, backup data shadowing, security, data tagging and time stamping, customization, caching, statistical processing, and capacity planning, and the like) can be implemented all within the same system 100 by creating and providing multiple different virtual driver interceptors or wrapper software into the system 100 as illustrated by stack 106 of many drivers. In fact, the caching virtual driver may assist, for example, in creation of the shadow copy and fault recovery wrapper creation where the more wrapper or virtual drivers that are created result in some synergy.

FIG. 5 illustrates in more detail a specific implementation of one type of virtual driver interceptor 130 which is referred to as a virtual wrapper. FIG. 5 illustrates that the virtual interceptor software is usually wrapped in close proximity and/or close relationship to the existing drivers 110. In other words, the wrapper software and existing/standard driver software are usual integrated in close coupling to each other or may even be integrated together into the same driver code. These drivers and virtual interceptors generally have a backend software interface 132 for communicating with the backend 112 of FIG. 4 and a front-end software interface 136 for interfacing with the API's 104 and applications 102 of FIG. 4. In the event of stacked drivers, the software 132 and/or 136 may actually interface to a next driver within the stack of drivers 106.

Between the backend software interface 132 and the front-end software interface 136 in FIG. 5 is the core driver software 134. Within the driver software are various functions, classes, or subroutines 138 through 144 that are taken from standard drivers that exist today or will be created as standard drivers in the future. Some classes or functions, such as classes 138 and 140, are software programs, subroutines, software objects, functions, or software modules that simply handle transactions where data is sent from the backend system to the front-end system in FIG. 4. In other cases, classes or modules are resident within the driver software 134 to process incoming queries or incoming commands from the front-end to the backend system, like classes 142 and 144 in FIG. 5. While FIG. 5 illustrates that the classes 138 and 140 are use to process information coming from the backend and going to the front-end whereas classes 142 and 144 are intended to process information and queries coming from the front-end and going to the backend most driver software segments 134 contain tens or hundreds of specific classes that are used for specific information or query communication tasks.

FIG. 5 specifically illustrates that the classes which process data coming from the backend are not in need of any virtual wrapper or virtual interceptor processing in some applications, and that the classes 138 and 140 need interception in these applications. Therefore, FIG. 5 illustrates, in some embodiments, that only the classes 142 and 144 which process queries or instructions coming from the front-end to the backend require virtual interceptor processing, where the classes 142 and 144 are illustrated as having virtual wrapper software 146 and 148 appended thereto which enable the one-way interception.

In summary, the specific one-way interception construct of FIG. 5 specifically illustrates the virtual interceptor construct that would probably be used in a system that has been “interceptor enabled” in order to provide versioning within a system 100. FIG. 5 illustrates that some virtual driver interceptors need not intercept all information passing through all classes of a driver but may only need to intercept queries or information passing through certain classes within the driver software. This is true for adding versioning functionality to a database because the classes 138 and 140 simply pass information handed to them from the backend to the front-end. Since these classes 138 and 140 do not care where the information came from there is no custom processing that needs to occur in classes 138 and 140 when versioned information is being passed from the backend to the front-end. However, when a query is coming from the front-end to the backend, it is important to intercept these queries and information in order to detect when a version call is being made and changes the instruction or query to reflect that version information. Therefore, the front-end to backend classes 142 and 144 contain virtual wrapper software to intercept queries and instructions, process the instructions with the schema database 108 of FIG. 4, and modify the instruction as is necessary in order to ensure the proper version stored in the backend system 112 is accessed and presented to the front-end.

It is important to note that while FIG. 5 illustrates one-way interception from the front end to back end only, the reverse may also be true. For example, some applications may require that the classes 138 and 140 that process information from the backend to the front end may need wrapper intervention while incoming information through classes 142 and 144 may not need such processing. One example is the case of data conversion. Assume that a database contains schematic data of the dimensions of a house. Assume that this information is in feet. This is OK in the US and a US user could access the data through classes 142 and 144 and receive the data through 138 and 140 without interception and get feet dimensions. However, another builder in the UK may want to see the measurement in meters. In these cases, the UK builder can make the same unintercepted query into the database per classes 142 and 144 of FIG. 5. However, a virtual wrapper appended to the classes 138 and 140, in this case, could intercept the data and convert it to meters for the UK entity.

FIG. 6 illustrates a second embodiment which may be used to construct a virtual driver interceptor within the system 100 of FIG. 4. FIG. 6 illustrates a backend software interface 152 and a front-end software interface 156 very similar to that illustrated in FIG. 5. FIG. 6 also illustrates driver software 154 which is generally a combination of a driver 110 and the virtual driver interceptor software 106 from FIG. 4. While the driver software generally contains many classes or functions, four classes 158 through 164 illustrated in FIG. 6. Unlike FIG. 5, the virtual driver interceptor software 166 in FIG. 6 is layered across all of the classes within the driver software. There are some embodiments and desired database functionality that could be added to system 100 by a virtual driver interceptor that requires all classes to be intercepted and potentially modified on an ad hoc basis. One such example is caching where incoming requests from the front-end to the backend must be intercepted and processed at the cache to see if a hit or miss has occurred, and information coming from the backend to the front-end must be intercepted for storage within the cache databank for cached access at a later time. Therefore, the stacked wrappers 106 illustrated in FIG. 4 are generally structured in one or two of the embodiments illustrated in FIG. 5 and FIG. 6, and combination of these two virtual driver constructs can be existing in the same system 100 in a stacked manner.

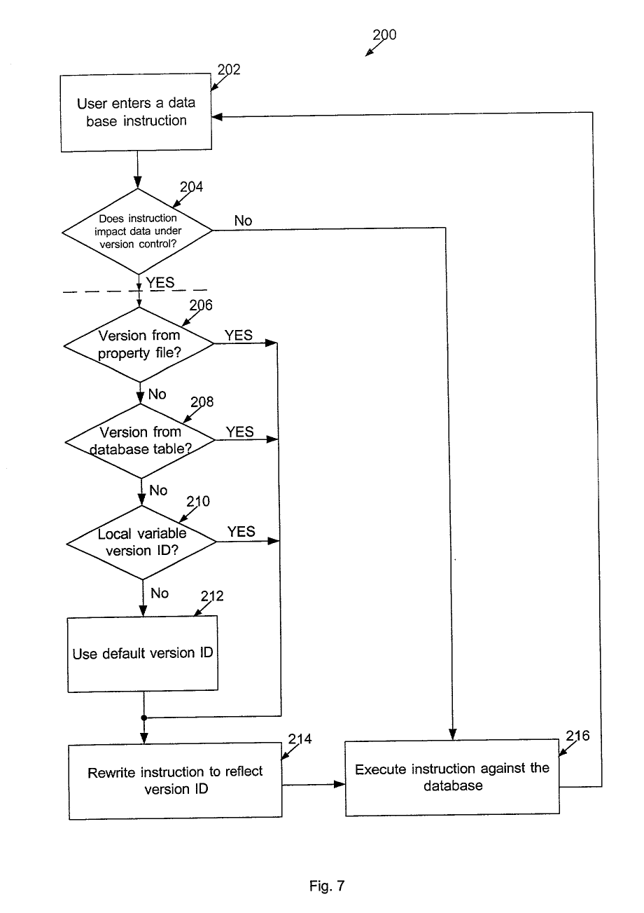

FIG. 7 illustrates, in a flow chart, one process which may be used to enable versioning within the system of FIG. 4. Note that all interception will perform a function similar to that illustrated in FIG. 7 whereby FIG. 7 could easily represent any interceptive process occurring in either of FIGS. 5-6. In addition, the process of FIG. 7 can be used for both a write or copy operation performed from a front end to a date base or a data read operation where information is sent from the database to the application (i.e., in other words, this FIG. 7 can cover interception in either direction in FIG. 4). In both cases, method 200 of FIG. 7 begins by a user entering some data base instruction in a step 202 through use of an application 102 in FIG. 4. In a step 204 of FIG. 7, the system of FIG. 4 will detect whether or not the instruction is impacted by version control within the wrapper stack 106. If the instruction exchanged between the front end application 102 and the back end data base 112 is not effected by versioning, then the step 204 transfers control to a step 216 and the instruction is passed through the virtual driver interceptor stack 106 unchanged to the standard drivers and the back end data base 112 for execution an retirement by the system 100. If the virtual driver interceptor 106 determines that the instruction currently provided from the application requires access to a specific version, then the steps 206-212 of FIG. 7 are performed.

In step 206, the virtual driver interceptor 106 first attempts to detect if the user or the system from which the user is accessing the data base has any version identifier within the schema data base 108 or in a local application property file within system 100. If version information is found at that location, then that information is used to effect change of the incoming instruction to a modified instruction via a step 214. If version information is not found in a property file, then the virtual interceptor may access data base tables at the data base 112 in an attempt to determine which version should be accessed by this instruction. If that information is found then the instruction is re-written to reflect proper version information is step 214, else step 210 is performed. In step 210, user programmable or hardware fixed local variables may reside on application computers that store the application 102. If this local variable is found or communicated with the query and is identifies the version to be accessed, then this information used in step 214, else step 212 is executed. In step 212, the previous steps 206-210 failed to achieve version identification and a default version identified is used for the query currently being processed.

It is important to note that there are many other techniques to identify which version is to be accessed via execution of software within the wrapper or virtual driver interceptor 106. In addition, the several methods taught within method 200 of FIG. 7 may be used independently of each other or in any hierarchical or parallel combination. In addition, the hierarchical order of checking of these various versions IDs can change in FIG. 7. Regardless of the method or location, version information is eventually obtained by the system and the instruction is modified in step 214 to reflect that version information. By way of example, the following base query entered by a user may be changed by the wrapper 106 of FIG. 4 to the following modified query by text/string processing or other techniques:

Base Query: Select * From Prices, Products where Prices.Product_ID=Products.Product_ID

Modified Query: Select * From Prices_vers12, Products where Prices.Product_ID=Products.Product_ID

The modified instruction, that now includes specific version information related to a specific version within the database backend 112, is provided to the database backend for execution via a step 216. Once the instruction is executed and information is provided back from the database 212 to the application 102 in response to the now intercepted query, the algorithm of FIG. 7 will repeat the method of FIG. 7 for additional user queries (if any). It is important to note that while the process of FIG. 7 illustrates how the virtual driver interceptor of FIG. 4 can enable versioning of data within the database, a similar process can also be used to perform security operations, data tagging, time stamping, fault tolerance and recovery, statistical analysis, load balancing, space planning, caching, or other operations that may be performed by any wrapper or virtual driver interceptor.

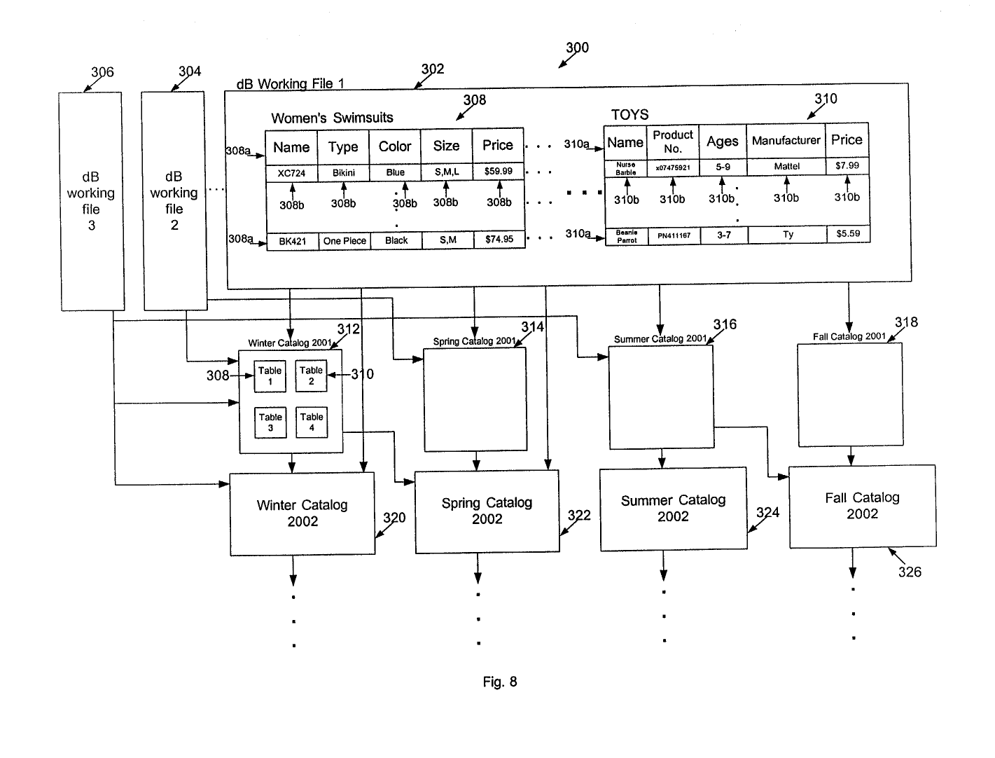

FIG. 8 illustrates how different versions of a database are created and rolled forward and rolled back within the database structure 212 of FIG. 4. Rolling forward and rolling backwards between tables, data records, data fields, and the like in a database is an advantage offered by this system over any of the prior art. For example, assume that you take the winter catalog data and make a new spring catalog and delete entire portions of data or change them significantly. If you then decide that all or a portion of these changes are not acceptable, you can roll back to the winter data with a click of a button in system 100 of FIG. 4 since dynamic versions of all that data are readily present and accessible within the system in parallel to each other through the wrappers and virtual drivers.

In FIG. 8, the database 300 illustrates three working files 302, 304, and 306 which form the basis for creation of all data going forward. Basically these three working files are three different databases that may be stored on the same storage systems or on different storage systems or different apparatus within the database back-ends 212 of FIG. 4. Each database working file 302-306 in FIG. 8 can collect different information from different sources in different formats. For example, one format may be in Microsoft SQL and another format may be based on Oracle software. Regardless, each database working file 302-306 contains a hierarchy of data, that is tagged or indexed, and may have relationships therebetween. Each database working file 302-306 contains one or more data tables. In FIG. 8, database 302 is illustrated as having at least two data tables 308 and 310. Within the respective data tables 308 and/or 310 are columns that indicate certain properties of the data within the table. For example, the table 308 contains at least five columns that identify the name of a woman's swimsuit, its type, color, size, and price. Each record within the table 308 is a row of information that fills in each of the at least five columns with appropriate information. By way of example, table 308 is illustrated as having at least two records 308a and table 310 is illustrated as having at least two records 310a. Each record within each of the tables 308 and 310 contains entries or fields 308b and 310b.

FIG. 8 illustrates that multiple instantiations or versions of the database or portions of the database may be assembled and created in the back-end 112 of FIG. 4 from previous data. By creating multiple functional dynamic database constructs, many different databases with similar yet different information can be simultaneously processed, accessed, and changed at a single point in time using existing APIs, applications, standard drivers, and backends. In addition, due to the presence of the virtual layer 106 in FIG. 4, such different versions can be maintained on the back-end without requiring any, or at least not significant, changes to the back-end software, drivers 110, API 104, or applications 102 in FIG. 4.

In order to create new dynamic database content, an application or utility program can allow an end-user to select which portions of the data it wishes to version as a new version from the base database material 302-306. The data version from the existing database information 302-306 can be at any stage in the data construct hierarchy (i.e., selection can be made from the database level, the table level, the record, level, or the entry level, or some hybrid thereof). As an example, FIG. 8 illustrates that the dynamic data winter catalog 312 is formed by selecting different tables from different existing databases 302-306. Note that the tables 308 and 310 have been shown as being selected as one of the four tables for the winter catalog 312 in FIG. 8. Note that while new database constructs or versions within the system of FIG. 4 may be created by selecting entire databases, individual records within databases, or entries within records, it is more common for entire tables to be selected to create the new versions illustrated in FIG. 8.

Once selected and assembled in a new version 312, winter catalog information can be entered into the data of 312 without effecting the base data of 302-306. At the same time, other users may be selecting dynamic tables or like constructs to create dynamic copies of a spring catalog 314, a summer catalog, 316, and/or a fall catalog 318 as shown in FIG. 8. Again, all of these new versions of portions of the databases contain dynamic data and can be accessed and changed as a database through the same applications, APIs, drivers, and back-end without need for significant change due to the presence of the virtual driver interceptor software 106 of FIG. 4. Therefore, it is possible for the winter team to be working and manipulating data in version 312 which was derived from databases 302306 while a spring catalog team can be working on version 314 which was assembled from the database working files 302 and 304. Further, the summer catalog 316, that is assembled from the database working file 302 and working file 306, can also be simultaneously accessed and changed with the spring and winter catalogs 314 and 312. Also, a fall catalog 318, that is created from only the database working file 302, may also be in the process of creation and use in conjunction with the other database files 312-316.

Note that each dynamic database file 312-318 may be modified or changed independently of the other without affecting the content of the other. In addition, should errors be made, new content be desired within any new version, or old content need to be reloaded into any version 312318, any database, table, record, field, or file can be rolled back and forth between base versions previous versions or the existing version. Applications and utilities make it very easy to roll data between the various versions illustrated in FIG. 8 by virtue of the fact that all of the database information in FIG. 8 is separately maintained in each version 312-318. Roll back and roll forward operations on partial segments of data within information is impossible, if not incredibly difficult, to do on a database containing purely static information or on database applications that creates static content output as the final product.

Furthermore, roll forward and roll back can be done in FIG. 8 using the system of FIG. 4 on a time creation basis where if a version was time stamped as being formed before the current version, data can be rolled back and forth from the current version to the older time stamped version. However, another construct may be that data within a particular version can only be rolled back to hierarchically preceding versions from which its content depends. For example, eventually the next year's catalogs 320, 322, 324, and 326 are created as shown in FIG. 8. Catalog 320, which is a new version of dynamic data for a new winter catalog for the year 2002, is shown as being created from the file 302, the file 306, and the old version of winter data 312. With a time-based roll back system, the winter catalog 320 could be rolled back to any of the previous databases information within files 302-318. However, in another embodiment that uses hierarchical rollback and roll-forward, the winter catalog 320 may only be capable of being rolled back and rolled forward between the pre-existing data located in 302, 304, 306, and 312. In essence, FIG. 8 shows that multiple instantiations or versions of a database may be created in the back-end 112 and accessed through standard back-end driver, API, and applications software without need for significant change by virtue of the presence of the virtual driver interceptor 106 and that data between the versions may be rolled back and rolled forward effectively and efficiently.

As an added feature, once the dynamic database constructs of FIG. 8 create a final version of data that is believed to be satisfactory, a static version or released version of that data may be generated and output for access by end users. A released version is a locked or secure version of the data that prevents tampering. If a dynamic database version, like version 320 is accessed by a user, the information may be overwritten, hacked, or damaged, whereas a static version is less likely to cause such damage and harm. If the released version is destroyed or tampered with, it can be regenerated from the dynamic file 320 without delay. Further released versions prevents data tampering in older versions of data that may need to be relied upon at a later date for definitive roll back and roll forward operations.

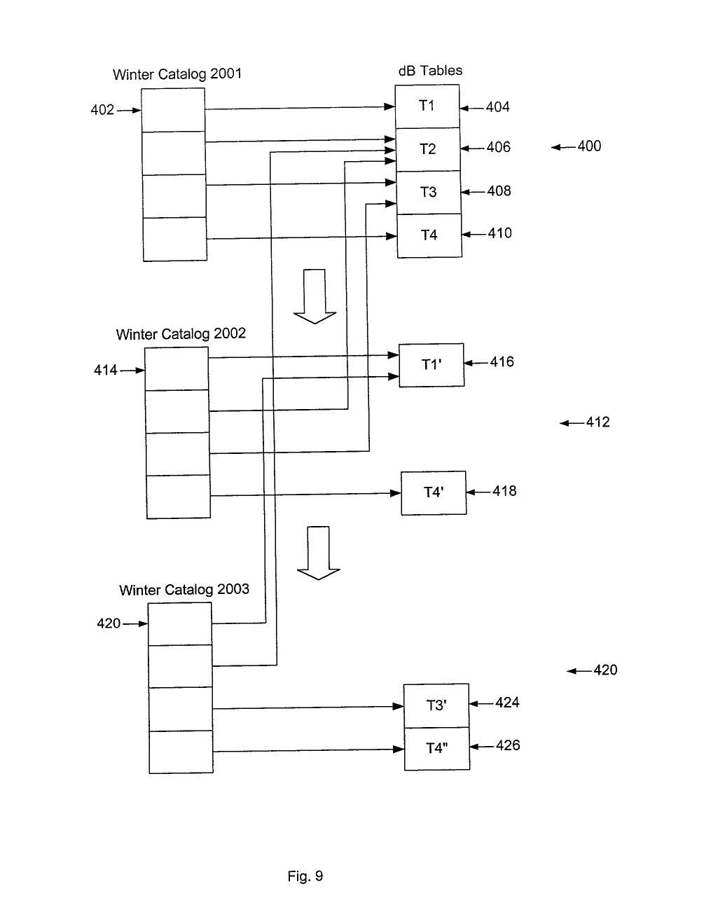

FIG. 9 illustrates one method which may be used to create the various versions of dynamic data illustrated in FIG. 8. FIG. 9 illustrates that a 2001 winter catalog contains four dynamic data tables 404-410. FIG. 9 illustrates that this winter catalog 402 is organized through a root array of pointers 402, where each pointer points to a specific data table 404-410 to collectively comprise the entire winter catalog. When a user identifies that the new winter catalog or new version information should be created, the new version may be created as illustrated by version 412 in FIG. 9. In a first embodiment, a user may be asked by a utility, IT person, or application elect all of the tables within all of the databases that are necessary in order to form the next version 412. In this first embodiment, all the pointers in the ray of pointers 414 are originally set to point to the original database tables 404-410 that are already created and resident within the backend.

Dynamically, as a user accesses those tables 404-410 and changes information for the version 412, the virtual driver interceptor software 106 will detect the first change and creates copies of the changed tables as they are changed for the first time. For example, in FIG. 9, all the pointers of array 414 were initially set to point to tables 404-410. A user changed in the version 412 the table 404, which trigger a virtual wrapper or driver process that copied the table 404 to table 416, made the change in table 416 (to preserve the original table 404), and changed the pointer in array 414 to point to the newly crated table 416. The same dynamic detection, copy, make change, and change pointer operation is also shown in FIG. 9 to have occurred for table 410 since a table 418 is now shown as a part of the Winter Catalog 2002. In version 412, a user tried to change table 410 and the interceptor 106 detected the change and copied the table information to another table 418, made the change, and coupled that table into the array of pointers 414. Therefore, FIG. 9 illustrates a dynamic method for allocating memory among versions and keeping track of tables based only upon the absolute need of the system to create and use additional memory when changes are made to pre-existing data tables, records, or entries.

Similarly, version 420 is created where a user selected the tables 406, 416, 408, and 418 initially as the tables through which the next winter catalog would be derived. As users entered new changes into these selected tables, the table 408 and the table 418 were changed within version 420 thereby resulting in the creation of the new tables 424 and 426, the rendering of the change in these new tables, and the changing of the two pointers in the array of pointers 420 Therefore, the process illustrated in FIG. 9 is a dynamic memory allocation process which is triggered upon sensing changes in pre-existing data tables. While this process may be a bit more complex, this process may preserve a significant amount of memory over time since database systems can consume a significant amount of disk space.

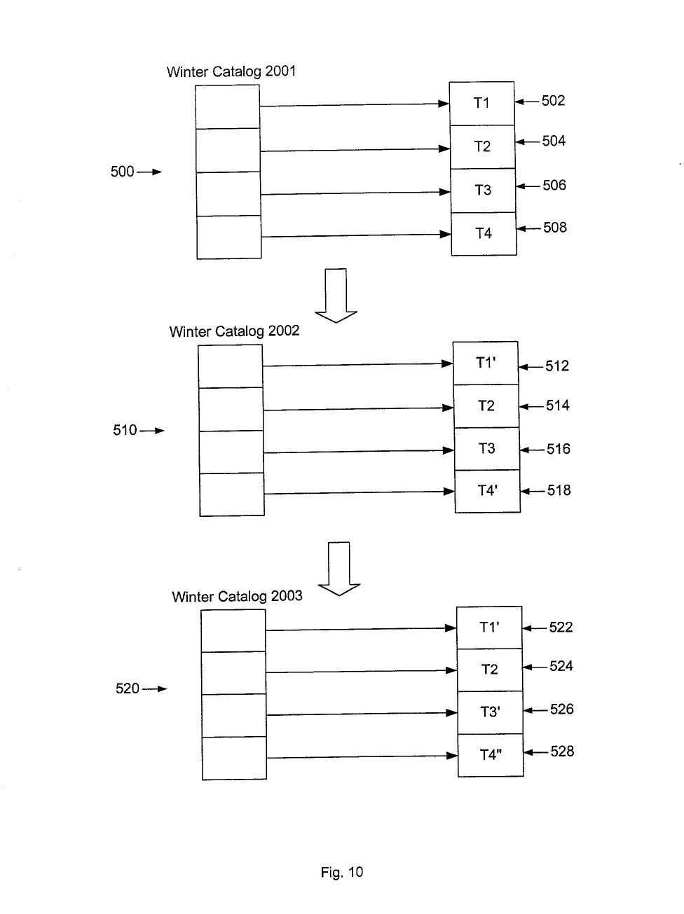

FIG. 10 illustrates a second embodiment which may be used to form the different versions illustrated in FIG. 8. In FIG. 10, a first version 500 is formed whereby a pointer array points to all of the tables within the version 502-508. When a new user elects to create a new table and happens to select one or more tables from pre-existing databases, then FIG. 10 illustrates that the new version 510 makes copies 512-518 of all of the selected tables 502-508 (assuming all were selected) regardless of whether or not these tables are changed by the user over time. Likewise, when a new version 520 is elected for creation by a end user where the selected tables are 502, 504, 506, and 518, FIG. 10 illustrates that all of these tables are copied to new tables 522-528 and so on. Therefore, even though the tables 512 and 518 were the only tables changed in the version 510, all four tables 512-518 are copied and versioned. While this may waste some memory space within disk arrays and long term storage, the implementation of this process is believed to easier to code and easier to manage than the process illustrated in FIG. 9.

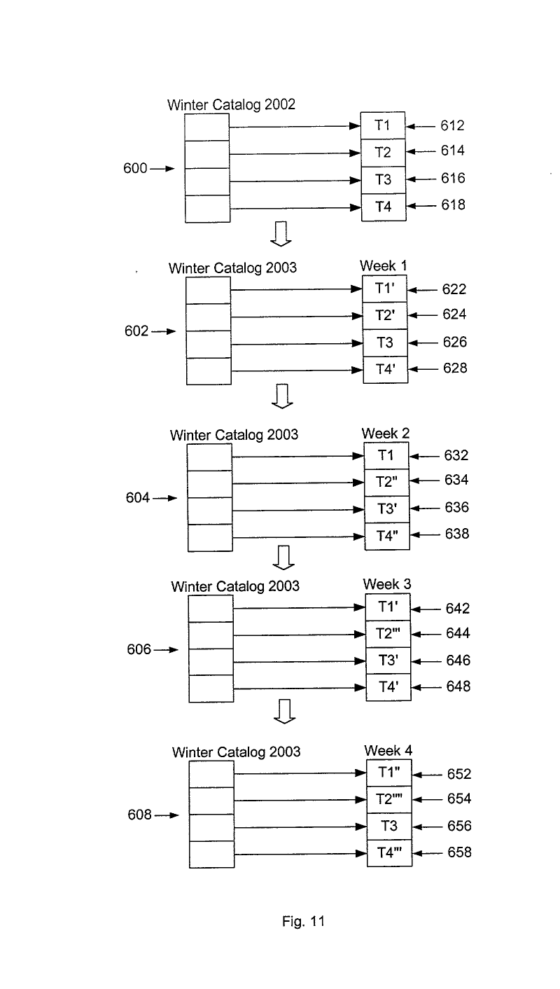

FIG. 11 illustrates a two-tier method for versioning documents within the system of FIG. 4 using the file structure illustrated in FIG. 10. FIG. 11 illustrates that versions of documents can be created under user control and identified as illustrated in FIGS. 8-10. For example, in FIG. 11, a first version of data 600 having tables 612-618 has been selected in whole or in part to create a new user created version 602 having tables 622-628. Once this new version 602 is created the selected tables 612-618 are copied to tables 622-628 per the method of FIG. 10 for simplicity of illustration. Note that the version 602 indicates that the data within the table 612, 614, and 628 were changed in version 602 as compared to 600.

In addition to user selected versioning for whatever reason, an end user may select to perform time-based versioning of the data to ensure that there are adequate back-ups of data versions in the events of loss or error. Of course, other triggers of this second tier back-up exist, other than time, such as backups based on dynamic detection of changes or on user creation of a released version, etc. Once this second backup tier option is selected, the system of FIG. 4 may systemically begin to create time-based backups or new versions of the version 602 either based upon the occurrence of certain events, a repetitive and periodic time duration, like criterion, or other criteria. FIG. 11 illustrates that an end user selected a one-week fixed-time backup period and that back-up version 604-608 were created each week automatically by the system as time progressed. This automatic creation of backup may automatically update the schema data of file 108 so that only the most recent time based version is accessible by the user unless the user or an IT file designated otherwise. Should any error or problem occur whereby data needs to be rolled back, wholly or partially, to previous timed versions or previous winter catalogs, the preservation of this data within the system of FIG. 4 and the ability of existing applications and databases to be rolled back and rolled forward easily via the presence of the virtual wrapper 106 ensures that the system 4 is flexible and secure.

While the virtual wrapper and virtual driver data base system, methodologies, constructs, and uses are taught herein and have been illustrated and described herein with reference to specific implementations, further modifications and improvements will occur to those skilled in the art. For example, while the virtual programs are taught herein as being integrated or associated with the drivers, the virtual software may be integrated or provided anywhere between the front end and the back end, such as at the API layer. It is to be understood, therefore, that the claims should not be limited to the particular forms and embodiments illustrated herein and that it is intended that the appended claims cover all modifications that do not depart from the spirit and scope of this invention.

What is claimed is:

1. (Partial Wrapper claim) Software for communicating database information between a front end system and a back end system, the software comprising:
front end software that receives information from the front end system and provides information to the front end system;
back end software that receives information from the back end system and provides information to the back end system;
driver software communicatively coupled between the front end software and back end software, the driver software containing a plurality of classes adapted to service incoming and outgoing information between the front end software and back end software; and
interceptor software operably coupled to a fraction of the plurality of classes, the interceptor software being designed to intercept instructions passing through the driver software and change the instructions to modified instructions before the instruction is passed out of the driver software.

2. The software of claim 1 wherein back end system is a plurality of back end database servers that contain different data for different operations within an enterprise.

3. The software of claim 1 wherein front end system is at least one computer that contains application programming interface software and end user applications that interface to the driver software.

4. The software of claim 1 wherein front end software, the back end software, the driver software, and the interceptor software are all portions of the same software program stored in a common memory bank for execution by a central processing unit.

5. The software of claim 1 wherein the driver interfaces with user specific schema data that assists the driver in determining whether or not to change the instructions to modified instructions before the instruction is passed out of the driver software.

6. The software of claim 1 wherein the driver interfaces with system specific schema data that assists the driver in determining whether or not to change the instructions to modified instructions before the instruction is passed out of the driver software.

7. The software of claim 1 wherein some instructions are changed to modified instructions and other instructions are passed through the driver without change.

8. The software of claim 7 wherein the instructions that are intercepted and changed to modified instructions are only those incoming database requests from the front end system that access data at the backend system whereas all database provisions from the back end system to the front end system are not intercepted or changed.

9. The software of claim 1 wherein the instruction is changed in order to allow data in the back end to be versioned whereby multiple different versions of data from the backend are created and independently accessible and changeable at one time via the creation of modified instructions via the interception software.

10. The software of claim 1 wherein the instruction is changed in order to allow data in the back end to be given different security levels whereby different users are granted different levels of access to data via the creation of modified instructions via the interception software.

11. The software of claim 1 wherein the instruction is changed in order to add tag information to the instruction via the modified instruction.

12. The software of claim 11 wherein the tag information is one or more of: a time stamp; an origination identifier, or a date stamp.

13. (intercept only FE to BE Transactions) Software for communicating database information between a front end system and a back end system, the software comprising:
front end software that receives information from the front end system and provides information to the front end system;
back end software that receives information from the back end system and provides information to the back end system;
driver software communicatively coupled between the front end software and back end software, the driver software processing information that going to coming from either the back end system or the front end system; and
interceptor software coupled to intercept only database instructions coming from the front end system and destined for the back end system where the interceptor software intercepts these database instructions and determines if the database instruction requires modification before transmission to the back end system.

14. The software of claim 13 wherein the database instruction is modified in some cases and passed in an unmodified format in other cases.

15. The software of claim 13 wherein the database instruction is modified using control information read from a central user or system property file.

16. The software of claim 13 wherein the database instruction is modified using control information read from a central user or system database table in memory.

17. The software of claim 13 wherein the database instruction is modified using control information read from a local variable stored at the front end system.

18. The software of claim 13 wherein the database instruction is modified using control information read from default location.

19. The software of claim 13 wherein the database instruction is modified using hierarchical control information read from two or more of a central user or system property file, a central user or system database table in memory, local variable stored at the front end system, or default location.

20. The software of claim 13 wherein the database instruction is changed in order to allow data in the back end to be versioned whereby multiple different versions of data from the backend are created and independently accessible and changeable at one time via the creation of modified instructions via the interception software.

21. The software of claim 13 wherein the database instruction is changed in order to allow data in the back end to be given different security levels whereby different users are granted different levels of access to backend data via the creation of modified instructions via the interception software.

22. (Stacked Virtual Layer claim) Software for communicating database information between a front end system and a back end system, the software comprising:
front end software that receives information from the front end system and provides information to the front end system;
back end software that receives information from the back end system and provides information to the back end system;
driver software communicatively coupled between the front end software and back end software, the driver software processing incoming and outgoing information between the back end software and the front end software; and
a plurality of stacked virtual control software modules coupled between the front end system and the back end system to intercept information and instructions passed through the driver software between the front end system and the back end system, each of the stacked virtual control software modules in the plurality enabling a different database function.

23. The software of claim 22 wherein the plurality of stacked virtual control software modules contain at least two modules and the two modules perform different functions selected from a group consisting of: caching of data from the back end system; versioning of data within the backend system; security of data within the backend system.

24. (Dynamic Versioning) Software for communicating database information between a front end system and a back end system, the software comprising:
front end software that receives information from the front end system and provides information to the front end system;
back end software that receives information from the back end system and provides information to the back end system;
version control software that allows dynamic data on the back end to be version controlled whereby multiple different versions of dynamic data are present and separately accessible on the back end system at a given time; and
driver software communicatively coupled between the front end software and back end software, where the driver software ensures that different end users using the front end software may independently and simultaneously access different versions of dynamic data on the back end system.

25. The software of claim 24 wherein the version control software allows an end user to select in advance those portions of the dynamic data in the back end system what will be used to create a new version and then creates the new version from the those potions.

26. The software of claim 24 wherein the version control software allows an end user to start editing existing data within the dynamic data where as dynamic data within segments of the back end system are changed, these segments are copied to create a new segment so that the existing segment is not changed and the new segment is changed and becomes part of the new version.

27. The software of claim 26 wherein the segments are one or more of:
separate back end servers, separate databases on the backend system, different tables within databases, different records within tables, or different fields within records.

28. The software of claim 26 wherein the segments may be rolled back to any segments of any version created prior to the time the version was created.

29. The software of claim 26 wherein the segments may be rolled forward to any segments of any version created after the time the version was created.

30. The software of claim 26 wherein the segments may be rolled back to any segments of any previous version upon which those segments were historically based.

31. The software of claim 26 wherein the segments may be rolled forward to any segments of any later version that were at one point derived from the current segment data.

32. (Nested two-tier versioning) Software for communicating database information between a front end system and a back end system, the software comprising:
front end software that receives information from the front end system and provides information to the front end system;
back end software that receives information from the back end system and provides information to the back end system;
first version control software that allows dynamic data on the back end to be version controlled whereby multiple different versions of dynamic data are present and separately accessible on the back end system; and
second version control software that allows each of the multiple different versions of the dynamic data to be further versioned within themselves wherein multiple different versions of the different versions of dynamic data are present and separately accessible on the back end system at a given time.

33. The software of claim 32 wherein the first version control software creates a base version of dynamic data based on user input, and wherein the second version control software creates time-dependent dynamic data backup versions of the base version of dynamic data on certain time intervals.

34. (version creation and changing) Software for communicating database information between a front end system and a back end system that contains many different segments of back end data, the software comprising:
front end software that receives information from the front end system and provides information to the front end system;
back end software that receives information from the back end system and provides information to the back end system;
version identification and creation software that allows a user to identify what select subportions of the back end data are needed to create a new version and accesses the select portions of the back end data and creates the new version from the select portions;
version editing software that allows a user to change the data within the new version while leaving the original back end data and other versions unaffected; and
version access software that allows an end user to access the data within the new version while leaving the original back end data unaccessed by the end user.

35. The software of claim 34 wherein the version identification and creation software allows the user to select up front which segments of data from the back end system are needed to create the version.

36. The software of claim 35 wherein the version identification and creation software allows the user to add segments at a later time.

37. The software of claim 35 wherein the version identification and creation software dynamically monitors a user's requests to change existing data segments and copies those segments to new version segments once the user request is made.

38. (roll forward and roll back) Software for communicating database information between a front end system and a back end system that contains starting back end data arranged in an information hierarchy, the software comprising:
front end software that receives information from the front end system and provides information to the front end system;
back end software that receives information from the back end system and provides information to the back end system;
version creation software that identifies and creates new data versions from starting back end data and previous data versions; and
version editing software that allows a user to one or either: (i) roll back information in a new data version to information in a previous data version or information in the many different segments of back end data; or (ii) roll forward information in a new data version to newer information associated with the new data version.

39. The software of claim 38 wherein the version editing software allows both: (i) roll back information in a new data version to information in a previous data version or information in the many different segments of back end data; or (ii) roll forward information in a new data version to newer information associated with the new data version.

40. The software of claim 38 wherein the version editing software allows roll back on a hierarchical level where the user may select a hierarchical segment of data that is to be rolled back, the hierarchical segment selected from a group consisting of: an entire database, a table in a database, a record type in a table, or fields in records.

41. The software of claim 38 wherein the version editing software allows roll back on performed on a conditional basis for a segment of data, where if data currently within a designated segment of a new data version meets a criterion it is rolled back, else that data is not rolled back.

42. (release concept claim) Software for communicating database information between a front end system and a back end system that contains starting back end data arranged in an information hierarchy, the software comprising:
front end software that receives information from the front end system and provides information to the front end system;
back end software that receives information from the back end system and provides information to the back end system;
version creation software that identifies and creates new data versions from starting back end data and previous data versions; and
version editing software that allows a user to change the data within the new version while leaving the original back end data unaffected;
version release software that allows a user to release the data within a version wherein the data in that version is thereafter protected from further data changes, yet that versions remains in a dynamic database format; and
version access software that allows an end user to access the data within the released version.

43. The software of claim 42 wherein a released version may be subsequently changed by creating a new unreleased version from the released version.

44. (data structure claim) A data structure for creating and maintaining many different versions of data that may be independently accesses and manipulated, the data structure comprising:
base data within a back end system that is configured into segments where each segments contains data and field identifiers for the data;
a first data version located at the back end system where data and field identifiers for the fist data version were derived from the base data; and
wherein the first data version and the base data may be independently manipulated and accessed via a set of common application programmers interfaces.

45. The data structure of claim 44 wherein a second data version is located at the back end system where data and field identifiers for the second data version were derived from the base data, the first and second data versions being independently accessible and changeable.

46. The data structure of claim 45 wherein a third data version is located at the back end system where data and field identifiers for the third data version were derived from the base data, the first, second, and third data versions being independently accessible and changeable.

47. The data structure of claim 45 wherein a third data version is located at the back end system where data and field identifiers for the third data version were derived from the base data and one or more of the first and second data versions, the first, second, and third data versions being independently accessible and changeable.

48. The data structure of claim 44 wherein a second data version is located at the back end system where data and field identifiers for the second data version were derived from the base data and the first data version, the first and second data versions being independently accessible and changeable.

49. The data structure of claim 45 wherein a third data version is located at the back end system where data and field identifiers for the third data version were derived from the base data, the first, second, and third data versions being independently accessible and changeable.

50. The data structure of claim 45 wherein a third data version is located at the back end system where data and field identifiers for the third data version were derived from the base data and one or more of the first and second data versions, the first, second, and third data versions being independently accessible and changeable.

51. The data structure of claim 45 wherein a schema database is accessed to determine which of the new data versions are accessible by an end user.

52. (method of FE to BE interception only) A method for accessing a database, the method comprising the steps of:
providing data within a database;
initiating one or more data access instructions from a front end interface;
intercepting the one or more data access instructions at a driver;
using the driver to determine if the data access instruction is an instruction that requires modification due to data versioning performed in the database;
modifying the data access instruction to add version information to the data access instruction and create a modified instruction when the driver detects that the data access instruction is making a versioned access;
providing a database instruction to the database, the database instruction being the modified instruction if versioned access is detected or being an unmodified version of the data access instruction when no version access is detected;
receiving the database information in response to the database instruction at the driver; and
returning the database information to a front end through the driver without interception.

53. (method of roll back) A method for accessing a database, the method comprising the steps of:
providing base data within a database;
creating a first version of data within the database from the base data, the first version of data being capable of independent access and change without affecting the base data;
creating a second version of data within the database from one or more of the base data and the first version of data, the second version of data being capable of independent access and change without affecting the base data or the first version of data;
creating a third version of data within the database from one or more of the base data, the first version of data, and the second version of data, the third version of data being capable of independent access and change without affecting the base data, the first version of data, or the second version of data;
determining that a portion of data in one of the above versions of data needs to be rolled back to a previous set of data from a specific previous version or the base data; and
changing the data in that portion of data to the corresponding older data present within the previous version or the base data to perform a roll back of the data.

54. (Multiple Versions claim) Software for communicating database information between a front end system and a back end system, the software comprising:
front end software that receives information from the front end system and provides information to the front end system;
back end software that receives information from the back end system and provides information to the back end system; and
driver software communicatively coupled between the front end software and back end software, the driver software having routines that allow for the creation and simultaneous access by users to a plurality of dynamic data versions accessible through the back end software where the driver software allows each of the dynamic data version to be changed without affecting the other.
